(19) United States
(12) Patent Application Publication
(10) Pub. No.: US 2025/0156679 A1
(43) Pub. Date: May 15, 2025

(54) COMPILATION METHOD, DATA PROCESSING METHOD AND APPARATUS THEREOF

(71) Applicant: MEDIATEK INC., Hsinchu City (TW)

(72) Inventors: PING-YUAN TSENG, Hsinchu City (TW); Jen-Chieh Tsai, Hsinchu City (TW); Sheng-Je Hung, Hsinchu City (TW); Chia-Wei Hsu, Hsinchu City (TW); PO-YEN LIN, Hsinchu City (TW); YEN-HAO CHEN, Hsinchu City (TW)

(21) Appl. No.: 18/945,680

(22) Filed: Nov. 13, 2024

Related U.S. Application Data
(60) Provisional application No. 63/598,142, filed on Nov. 13, 2023.

(51) Int. Cl. G06N 3/042; G06N 3/0464

(52) U.S. Cl. CPC G06N 3/042; G06N 3/0464

(57) ABSTRACT

The application discloses a compilation method, a data processing method and an apparatus thereof. Data representing a first graph characterizing the operations of a first neural network is obtained. The data representing the first graph is processed to transform the first graph into a second graph. A set of instructions for characterizing the second graph is generated. The set of instructions is provided to one or more hardware platforms.

This disclosure claims the benefit of US provisional disclosure Ser. No. 63/598,142, filed Nov. 13, 2023, the subject matters of which is incorporated herein by references.

### TECHNICAL FIELD

The disclosure relates in general to a compilation method, a data processing method and an apparatus thereof, and more particularly relates to a compilation method, a data processing method and an apparatus thereof with computational graph optimization in neural network (NN).

### BACKGROUND

With the rapid development of artificial intelligence (AI), deep learning accelerators (DLA) have become increasingly important components which are used to inference neural network on the edge devices.

Due to the limited memory resource on edge devices, the DL compiler, which is usually run on a compilation device (for example but not limited by, a computer having enough computation resources), must offer solutions to reduce memory footprint, minimize DRAM access and enhance cache memory utilization when DLAs do inference neural network on the edge devices.

In DL compilation, one known prior art, Symmetric Multi-Processing (SMP) graph, has a limitation that software (SW) tiles are scheduled in stage manner. Therefore, when DLAs do inference neural network on the edge devices based on the DL compilation results using SMP, it requires a whole buffer to store the stage output, and a stage must wait until the previous stage produces all the data, which is time consuming.

There needs a new compilation method and device thereof with computational graph optimization.

### SUMMARY

With this in mind, it is one object of the present invention to provide optimization-based auto graph transformation method and architecture for deep learning models that involve optimizing operational performance metrics such as memory footprint, DRAM access, and compile time, allowing it to balance trade-offs among different performance metrics and adapt to various scenarios.

According to an embodiment of the present disclosure, a compilation method is provided. The compilation method includes: obtaining data representing a first graph characterizing the operations of a first neural network; processing the data representing the first graph to transform the first graph into a second graph; generating a set of instructions for characterizing the second graph; and providing the set of instructions to one or more hardware platforms. The second graph includes a first partial transformed graph and a second partial transformed graph. The first partial transformed graph includes a plurality of convolution layers serially connected to generate a first partial output data based on a first part of an input data. The second partial transformed graph includes a plurality of concatenation layers and a plurality of convolution layers, wherein the concatenation layer of the second partial transformed graph receives convolution results from a corresponding convolution layer of the first partial transformed graph and a previous corresponding convolution layer of the second partial transformed graph and generates a concatenation result to a next corresponding convolution layer of the second partial transformed graph or as a second partial output data, and the convolution layer of the second partial transformed graph receives a second part of the input data or a concatenation result from a previous corresponding concatenation layer of the second partial transformed graph and generates a convolution result to a next corresponding concatenation layer of the second partial transformed graph.

According to another embodiment of the present disclosure, a data processing method is provided. The data processing method includes: receiving a set of instructions for characterizing a graph; obtaining input data; and performing the set of instructions on the input data for generating output data, wherein the graph includes a first partial transformed graph and a second partial transformed graph. The first partial transformed graph includes a plurality of convolution layers serially connected to generate a first partial output based on a first part of an input data. The second partial transformed graph includes a plurality of concatenation layers and a plurality of convolution layers, wherein the concatenation layer of the second partial transformed graph receives convolution results from a corresponding convolution layer of the first partial transformed graph and a previous corresponding convolution layer of the second partial transformed graph and generates a concatenation result to a next corresponding convolution layer of the second partial transformed graph or as a second partial output data, and the convolution layer of the second partial transformed graph receives a second part of the input data or a concatenation result from a previous corresponding concatenation layer of the second partial transformed graph and generates a convolution result to a next corresponding concatenation layer of the second partial transformed graph.

According to another embodiment of the present disclosure, a data processing apparatus is provided. The data processing apparatus includes: a processor, and a memory coupled to the processor. The processor is configured for: receiving a set of instructions for characterizing a graph; obtaining input data; and performing the set of instructions on the input data for generating output data. Wherein the graph includes a first partial transformed graph and a second partial transformed graph. The first partial transformed graph includes a plurality of convolution layers serially connected to generate a first partial output based on a first part of an input data. The second partial transformed graph includes a plurality of concatenation layers and a plurality of convolution layers, wherein the concatenation layer of the second partial transformed graph receives convolution results from a corresponding convolution layer of the first partial transformed graph and a previous corresponding convolution layer of the second partial transformed graph and generates a concatenation result to a next corresponding convolution layer of the second partial transformed graph or as a second partial output data, and the convolution layer of the second partial transformed graph receives a second part of the input data or a concatenation result from a previous corresponding concatenation layer of the second partial transformed graph and generates a convolution result to a next corresponding concatenation layer of the second partial transformed graph. The concatenation result for the next corresponding convolution layer is stored in the memory, and the next corresponding convolution layer reads the concatenation result from the memory, the convolution result for the next corresponding concatenation layer is stored in the memory, and the next corresponding concatenation layer reads the convolution result from the memory.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a multi-objective optimization based on tuned layer fusion and tensor tiling configuration according to one embodiment of the present invention.

FIG. 2 shows an example of the graph transformation pass of the compiler according to one embodiment of the application.

FIG. 3 shows comparison between the prior art and one embodiment of the application in the timing of generating the first partial data.

FIG. 4A and FIG. 4B show pipeline of multiple independent compute units according to prior art and one embodiment of the application, respectively.

FIG. 5 illustrates a multi-objective optimization based on tuned layer fusion and tensor tiling configuration according to one embodiment of the present invention.

FIG. 6A shows a compilation device according to one embodiment of the application.

FIG. 6B shows an apparatus according to one embodiment of the application.

FIG. 7 shows a compilation method according to one embodiment of the application.

FIG. 8 shows a data processing method according to one embodiment of the application.

### DETAILED DESCRIPTION

Technical terms are used in the specification with reference to the prior art used in the technology field. For any terms described or defined in the specification, the descriptions and definitions in the specification shall prevail. Each embodiment of the present disclosure has one or more technical features. Given that each embodiment is implementable, a person ordinarily skilled in the art can selectively implement or combine some or all of the technical features of any embodiment of the present disclosure.

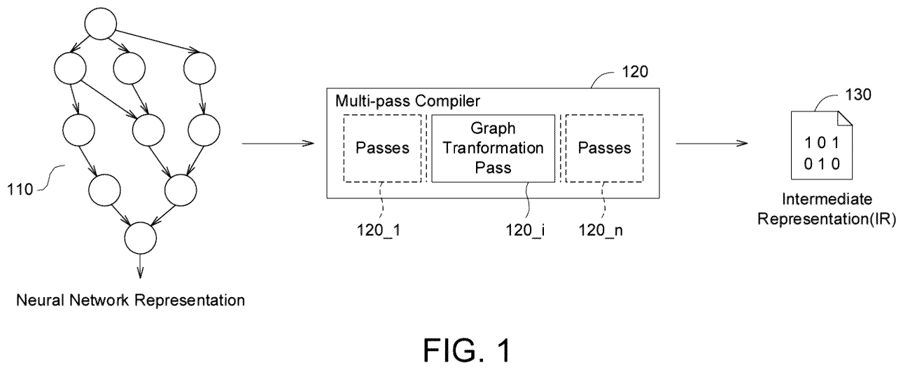

FIG. 1 illustrates a multi-objective optimization based on layer fusion and tensor tiling configuration according to one embodiment of the present invention. As illustrated, a trained deep learning model 110 will be inputted to a multi-pass compiler 120. The multi-pass compiler 120 has multiple passes 120_1-120_n (n being a natural number). The graph transformation pass 120_i, one of the passes 120_1-120_n in the multi-pass compiler 120, involves an automatic graph transformation method of the present invention. The multi-pass compiler 120 converts the trained deep learning model 110 into intermediate representations (IR) and converts the IRs to a set of instructions that can be efficiently executed on a target machine or hardware platform (e.g., deep learning accelerators (DLAs)).

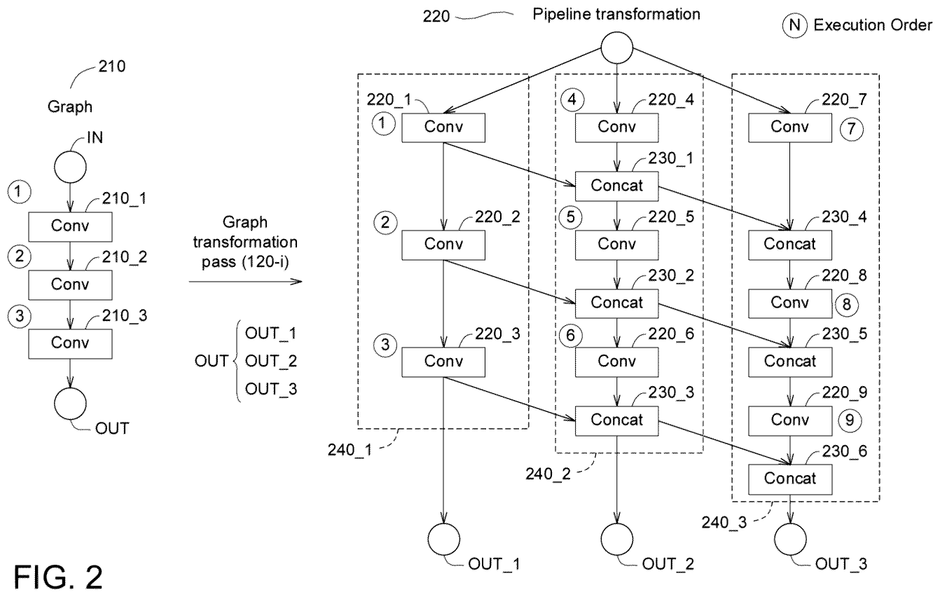

FIG. 2 shows an example of the graph transformation pass of the compiler according to one embodiment of the application. The graph 210 to be transformed by the graph transformation pass 120_i of the compiler 120 includes for example but not limited by, three convolution layers 210_1-210_3. The convolution layers 210_1-210_3 are serially connected. The first convolution layer 210_1 receives an input data IN and performs convolution operations on the input data IN to generate a first convolution result to the second convolution layer 210_2. Similarly, the second convolution layer 210_2 receives the first convolution result from the first convolution layer 210_1 and performs convolution operations on the first convolution result to generate a second convolution result to the third convolution layer 210_3. The third convolution layer 210_3 receives the second convolution result from the second convolution layer 210_2 and performs convolution operations on the second convolution result to generate an output data OUT for outputting.

After graph transformation by the graph transformation pass, the transformed graph 220 includes a plurality of convolution layers 220_1-220_9 and a plurality of concatenation layers 230_1-230_6. Wherein, in FIG. 2, the execution orders of the convolution layers 220_1-220_9 may be: 220_1, 220_2, 220_3, 220_4, 220_5, 220_6, 220_7, 220_8 and 220_9. That is, the convolution layer 220_1 is executed first and the convolution layer 220_9 is executed last. Also, the execution orders of the concatenation layers 230_1-230_6 may be: 230_1, 230_2, 230_3, 230_4, 230_5 and 230_6. That is, the concatenation layer 230_1 is executed first and the concatenation layer 230_6 is executed last. It is understandable that the convolution layers 220_1-220_9 may also be executed in other orders.

In one embodiment of the application, the graph transformation by the graph transformation pass is also referred as a pipeline transformation. That is, the plurality of convolution layers 220_1-220_9 and the plurality of concatenation layers 230_1-230_6 are pipelined to generate the output.

In details, in generating output data by the transformed graph 220 from the input data IN, the transformed graph 220 generates three partial output data OUT_1, OUT_2 and OUT_3, which the combination of three partial output data OUT_1, OUT_2 and OUT_3 is equal to the output data OUT generated by the graph 210.

In generating the first partial output data OUT_1, the first convolution layer 220_1 receives a first part of the input data IN and performs convolution operations on the first part of the input data IN to generate a first convolution result to the second convolution layer 220_2. Similarly, the second convolution layer 220_2 receives the first convolution result from the first convolution layer 220_1 and performs convolution operations on the first convolution result to generate a second convolution result to the third convolution layer 220_3. The third convolution layer 220_3 receives the second convolution result from the second convolution layer 220_2 and performs convolution operations on the second convolution result to generate a third convolution result as the first partial output data OUT_1 for outputting.

In generating the second partial output data OUT_2, the fourth convolution layer 220_4 receives a second part of the input data IN and performs convolution operations on the second part of the input data IN to generate a fourth convolution result to the first concatenation layer 230_1. The first concatenation layer 230_1 performs concatenation operations on the first convolution result (from the first convolution layer 220_1) and the fourth convolution result (from the fourth convolution layer 220_4) to generate a first concatenation result to the fifth convolution layer 220_5 and the fourth concatenation layer 230_4. The fifth convolution layer 220_5 receives the first concatenation result and performs convolution operations on the first concatenation result to generate a fifth convolution result to the second concatenation layer 230_2. The second concatenation layer 230_2 performs concatenation operations on the second convolution result (from the second convolution layer 220_2) and the fifth convolution result (from the fifth convolution layer 220_5) to generate a second concatenation result to the sixth convolution layer 220_6 and the fifth concatenation layer 230_5. The sixth convolution layer 220_6 receives the second concatenation result and performs convolution operations on the second concatenation result to generate a sixth convolution result to the third concatenation layer 230_3. The third concatenation layer 230_3 performs concatenation operations on the third convolution result (from the third convolution layer 220_3) and the sixth convolution result (from the sixth convolution layer 220_6) to generate the third concatenation result as the second partial output data OUT_2.

In generating the third partial output data OUT_3, the seventh convolution layer 220_7 receives a third part of the input data IN and performs convolution operations on the third part of the input data IN to generate a seventh convolution result to the fourth concatenation layer 230_4. The fourth concatenation layer 230_4 performs concatenation operations on the seventh convolution result (from the seventh convolution layer 220_7) and the first concatenation result (from the first concatenation layer 230_1) to generate a fourth concatenation result to the eighth convolution layer 220_8. The eighth convolution layer 220_8 receives the fourth concatenation result and performs convolution operations on the fourth concatenation result to generate an eighth convolution result to the fifth concatenation layer 230_5. The fifth concatenation layer 230_5 performs concatenation operations on the eighth convolution result (from the eighth convolution layer 220_8) and the second concatenation result (from the second concatenation layer 230_2) to generate a fifth concatenation result to the ninth convolution layer 220_9. The ninth convolution layer 220_9 receives the fifth concatenation result and performs convolution operations on the fifth concatenation result to generate a ninth convolution result. The sixth concatenation layer 230_6 performs concatenation operations on the ninth convolution result from the ninth convolution layer 220_9 and the third concatenation result (from the third concatenation layer 230_3) to generate a sixth concatenation result as the third partial output data OUT_3.

The combination of the first to the third partial output data OUT_1, OUT_2 and OUT_3 is the output data OUT.

That is, in one embodiment of the application, after graph transformation, the transformed graph includes a first partial transformed graph 240_1, a second partial transformed graph 240_2 and a third partial transformed graph 240_3.

The first partial transformed graph 240_1 includes a plurality of first convolution layers which are serially connected to generate a first partial output data based on the first part of the input data. For example, the first convolution layers of the first partial transformed graph 240_1 are the convolution layers 220_1-220_3.

The second partial transformed graph 240_2 includes a plurality of second convolution layers and a plurality of second concatenation layers. The second concatenation layer receives convolution results from a corresponding first convolution layer and a previous corresponding second convolution layer for generating a concatenation result to a next corresponding second convolution layer or as a second partial output data. The second convolution layer receives the second part of the input data or a concatenation result from a previous corresponding second concatenation layer for generating a convolution result to a next corresponding second concatenation layer. For example, the second convolution layers of the second partial transformed graph 240_2 are the convolution layers 220_4-220_6; and the second concatenation layers of the second partial transformed graph 240_2 are the concatenation layers 230_1-230_3.

The third partial transformed graph 240_3 includes a plurality of third convolution layers and a plurality of third concatenation layers. The third concatenation layer receives a convolution result from a corresponding third convolution layer and a concatenation result from a corresponding second concatenation layer for generating a concatenation result to a next corresponding third convolution layer. The third convolution layer receives the third part of the input data or a concatenation result from a previous corresponding third concatenation layer and generates a third partial output data or a convolution result to a next corresponding third concatenation layer. For example, the third convolution layers of the third partial transformed graph 240_3 are the convolution layers 220_7-220_9; and the third concatenation layers of the third partial transformed graph are the concatenation layers 230_4-230_6.

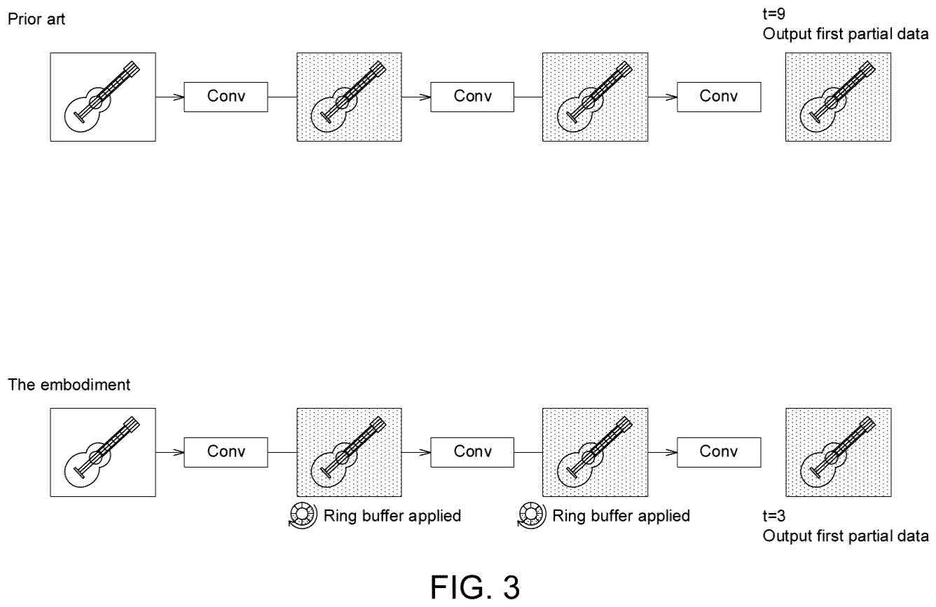

FIG. 3 shows comparison between the prior art and one embodiment of the application in the timing of generating the first partial data. In prior art, without pipeline graph transformation, when the target machine or hardware platform (e.g., deep learning accelerators (DLAs)) executes the set of instructions converted by the prior art compiler, the target machine or hardware platform (e.g., deep learning accelerators (DLAs)) generates the first partial output data at t=9 (i.e. the target machine or hardware platform (e.g., deep learning accelerators (DLAs)) generates the output data until all partial output data are ready). That is, it takes 9 units of time for the target machine or hardware platform (e.g., deep learning accelerators (DLAs)) to generate the first partial output data in prior art. On the contrary, in one embodiment of the application, with pipeline graph transformation, when the target machine or hardware platform (e.g., deep learning accelerators (DLAs)) executes the set of instructions converted by the multi-pass compiler 120, the target machine or hardware platform (e.g., deep learning accelerators (DLAs)) generates the first partial output data at t=3 as shown in FIG. 2 (i.e. the target machine or hardware platform (e.g., deep learning accelerators (DLAs)) generates the first partial output data even when all partial output data are not ready). That is, it takes 3 units of time for the target machine or hardware platform (e.g., deep learning accelerators (DLAs)) to generate the first partial output data in one embodiment of the application. With network pipeline and ring buffer mechanism, partial output data could be cached in ring buffer, and memory footprint therefore could be massively reduced. The ring buffer is inside or outside the target machine or hardware platform (e.g., deep learning accelerators (DLAs)).

As shown in FIG. 3, with network pipeline transformation, the time to generate the first output tile (i.e. the first partial output data) is reduced.

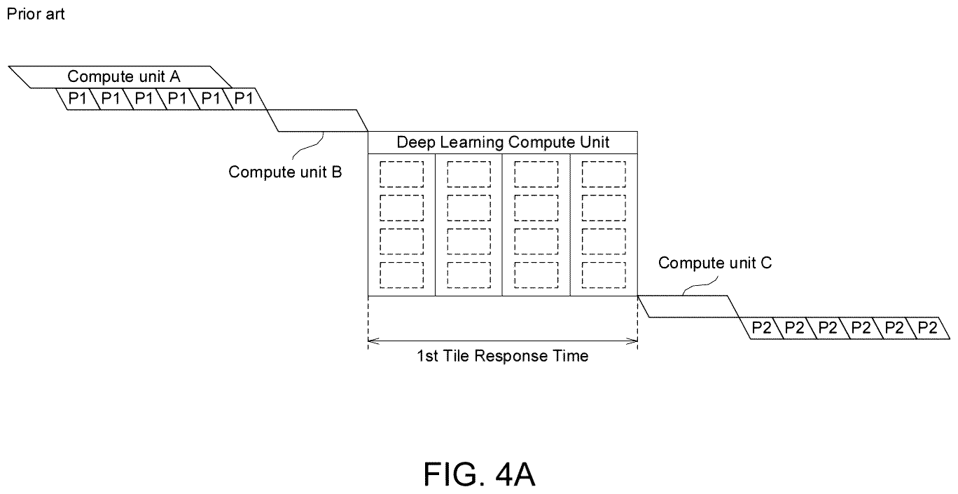

FIG. 4A and FIG. 4B show pipeline of multiple independent compute units according to prior art and one embodiment of the application, respectively. As shown in FIG. 4B, multiple compute units could also be pipelined, and the compute units can run once receiving partial data P1 which is needed. Thus, the total computation time in one embodiment of the application is reduced and throughput is enhanced. 1^{st} tile response time in FIG. 4B represents the time difference between the time when the input data is received by the graph transformation pass and the time when a first tile (e.g. the first partial output data) is output from the graph transformation pass.

In prior art of FIG. 4A, the compute units A, B and C have to wait until all needed partial data are ready, which is time consuming. For example, a compute unit B can only perform operations after all needed partial data P1 are ready by a previous compute unit A.

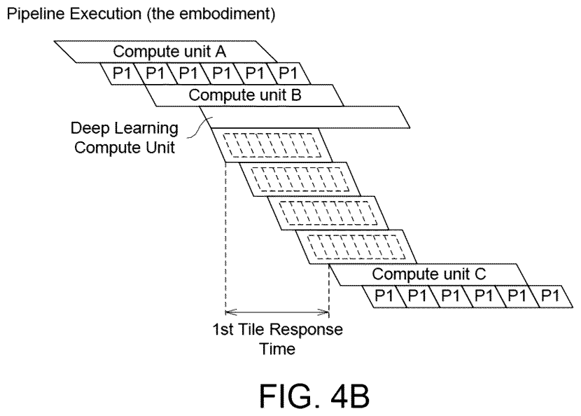

FIG. 5 illustrates a multi-objective optimization based on tuned layer fusion and tensor tiling configuration according to one embodiment of the present invention. As illustrated, a trained deep learning model 510 will be inputted to a multi-pass compiler 520. The multi-pass compiler 520 has multiple passes 520_1-520_n (n being a natural number). The graph transformation pass 520_i, one of the passes 520_1-520_n in the multi-pass compiler 520, involves an automatic graph transformation method of the present invention. The multi-pass compiler 520 converts the trained deep learning model 510 into intermediate representations (IR) 530 and converts the IRs into a set of instructions that can be efficiently executed on a target machine or hardware platform (e.g., deep learning accelerators (DLAs)).

The graph transformation pass 520_i of the passes 520_1-520_n includes a search fusion and tiling process 521, a schedule software (SW) tile execution order determination process 522 and a network pipeline transformation process 523.

The search fusion and tiling process 521 is for determining fusions and tiles. Specifically, the search fusion and tiling process 521 determines the number of tiles of the input data and divides each convolution layer in the trained deep learning model 510 into M convolution layers, wherein M is smaller than N or equal to N, wherein the different convolution layers divided from one convolution layer in the trained deep learning model 510 are in different partial transformed graphs, respectively. The first convolution layer in the trained deep learning model 510 is divided into N convolutions layers. The search fusion and tiling process 521 may determines fusions. Operation(s) in the same fusion can be performed without data movement between device (e.g. DLA) and temporary storage space, wherein the temporary storage space may comprise DRAM. In FIG. 2, one fusion comprises one convolution layer or one concatenation layer.

The schedule software (SW) tile execution order determination process 522 is for determining execution order of the SW tiles to reduce response time, wherein SW tiles comprise convolution layers and concatenation layers in the transformed graph 220. For example, the execution orders of the convolution layers 220_1-220_9 and the concatenation layers 230_1-230_6 are determined by the schedule software (SW) tile execution order determination process 522. A current partial transformed graph includes a plurality of convolution layers and a plurality of concatenation layers. The concatenation layer of the current partial transformed graph receives at least two inputs, wherein the one is a convolution result from a corresponding convolution layer of the previous partial transformed graph or a concatenation result from a corresponding concatenation layer of the previous partial transformed graph, and the other is a convolution result from a previous corresponding convolution layer of the current partial transformed graph. The concatenation layer of the current partial transformed graph generates a concatenation result to a next corresponding convolution layer of the current partial transformed graph or as a current partial output data. The concatenation result may be input to a corresponding concatenation layer of the next partial transformed graph.

The network pipeline transformation process 523 is for generating a transformed graph based on the execution orders of the convolution layers 220_1-220_9 and the concatenation layers 230_1-230_6. Operations and details of the network pipeline transformation process 523 are similar to the description related FIG. 2 and thus details are omitted here.

The memory allocation pass process 520_k (k being a natural number) of the passes 520_1-520_n is used to determine the concatenation result is stored in a ring buffer for the next corresponding convolution layer in the current partial transformed graph or a corresponding concatenation layer in the next partial transformed graph to read, and the convolution result is stored in the ring buffer for the next corresponding concatenation layer in the current partial transformed graph to read or for a corresponding concatenation layer in the next partial transformed graph to read. Details of the memory allocation pass 520_k are omitted here.

In one embodiment of the application, the auto graph transformation method adjusts network structure of deep learning model to be adaptive to target DLAs by layer fusion and tensor tiling technique. Layer fusion and tensor tiling can effectively leverage the memory to maximize resource utilization and performance. Specifically, layer fusion involves merging multiple consecutive layers (e.g. consecutive convolution layers) into a single layer. This can reduce movement of data between DLA and temporary storage space (e.g. DRAM), thus decreasing memory access overhead and the number of memory accesses. Tensor tiling, on the other hand, breaks down large tensors into smaller blocks, which optimizes data layout and access patterns in memory, thereby enhancing high-speed cache utilization and minimizing the amount of data accessed per memory access.

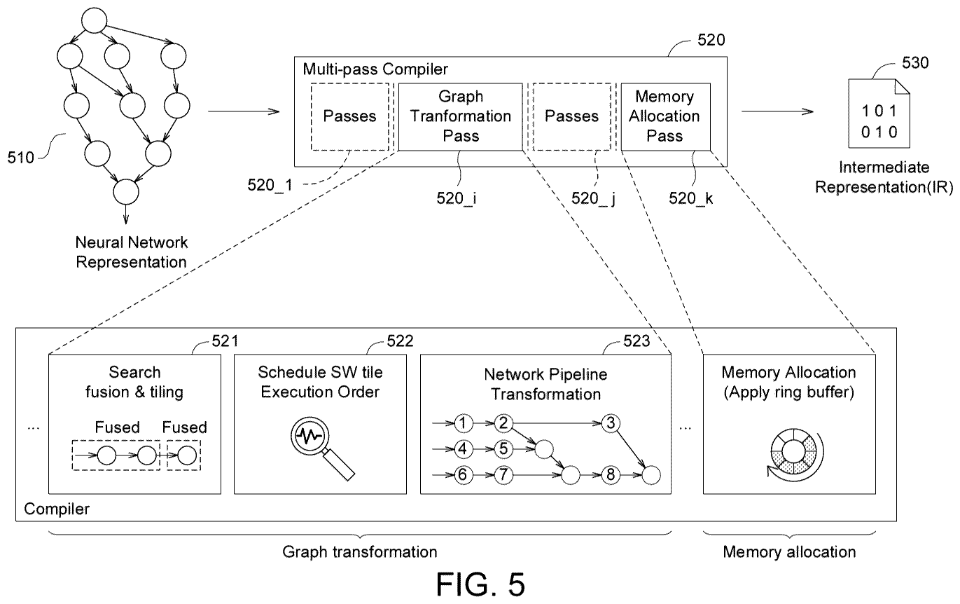

FIG. 6A shows a compilation device according to one embodiment of the application. As shown in FIG. 6A, the compilation device 600A according to one embodiment of the application includes a compiler 610 and a memory 620. The compiler 610 is coupled to the memory 620. The trained deep learning model (110 or 510) is stored in the memory 620. The compiler 610 performs the multi-pass compiler (120 or 520).

FIG. 6B shows an apparatus according to one embodiment of the application. As shown in FIG. 6B, the apparatus 600B according to one embodiment of the application includes a processor 650 and a memory 660. The processor 650 may couple to the memory 660. The memory 660 may be integrated into the processor 650. The processor 650 may be a DLA, and the memory 660 may a ring buffer. The processor receives a set of instructions for characterizing a graph. The processor receives input data and performs the set of instructions on the input data for generating output data. The apparatus 600B may be also referred as a data processing apparatus.

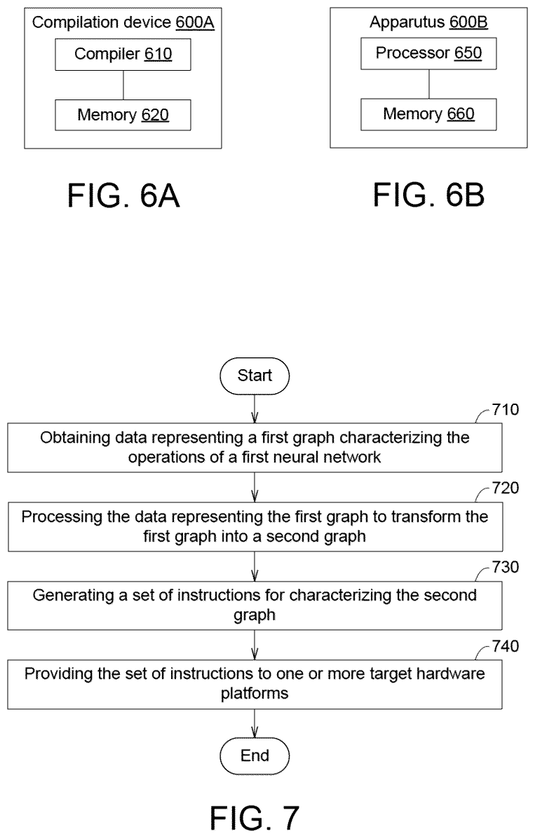

FIG. 7 shows a compilation method according to one embodiment of the application. The compilation method according to one embodiment of the application includes the following steps. In step 710, data representing a first graph characterizing operations of a first neural network (e.g. the trained deep learning model 110 or 510) is obtained. In one embodiment, the compiler obtains the first graph characterizing operations of a first neural network. In step 720, the data representing the first graph is processed to transform the first graph into a second graph. In step 730, a set of instructions for characterizing the second graph is generated. In step 740, the set of instructions is provided to one or more target platforms (e.g. target hardware platform). The second graph may be the graph 220.

Specifically, the second graph includes a first partial transformed graph and a second partial transformed graph, the first partial transformed graph includes a plurality of convolution layers serially connected to generate a first partial output data based on a first part of an input data, the second partial transformed graph includes a plurality of convolution layers and a plurality of concatenation layers, the concatenation layer of the second partial transformed graph receiving convolution results from a corresponding convolution layer of the first partial transformed graph and a previous corresponding convolution layer of the second partial transformed graph for generating a concatenation result to a next corresponding convolution layer of the second partial transformed graph or as a second partial output data, the convolution layer of the second partial transformed graph receiving a second part of the input data or a concatenation result from a previous corresponding concatenation layer of the second partial transformed graph for generating a convolution result to a next corresponding concatenation layer of the second partial transformed graph. The second graph further includes a third partial transformed graph, wherein the third partial transformed graph includes a plurality of convolution layers and a plurality of concatenation layers, the concatenation layers of the third partial transformed graph receiving a convolution result from a corresponding convolution layer of the third partial transformed graph and a concatenation result from a corresponding concatenation layer of the second partial transformed graph for generating a concatenation result to a next corresponding convolution layer of the third partial transformed graph, the convolution layer of the third partial transformed graph receiving a third part of the input data or a concatenation result from a previous corresponding concatenation layer of the third partial transformed graph and generates a third partial output data or a convolution result to a next corresponding concatenation layer of the third partial transformed graph.

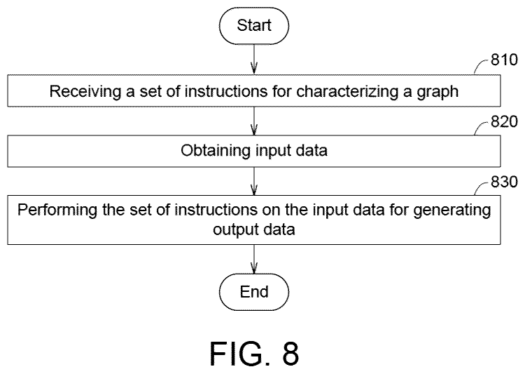

FIG. 8 shows a data processing method according to one embodiment of the application. In step 810, a set of instructions for characterizing a graph is received. The graph characterizes operations. The graph may be the second graph in the embodiment of FIG. 7. In step 820, input data is obtained. Specifically, in one embodiment, the input data is received. In step 830, the set of instructions is performed on the input data for generating output data.

In one embodiment, the steps 820 and 830 may be performed by a computing unit. The data processing method further comprises outputting the first partial output by the computing unit to a next computing unit before the second partial output is generated.

The concatenation result and the convolution result generated when executing the set of instructions may be stored in a ring buffer. Specifically, the concatenation result for the next corresponding convolution layer is stored in a ring buffer, and the next corresponding convolution layer reads the concatenation result from the ring buffer, the convolution result for the next corresponding concatenation layer is stored in the ring buffer, and the next corresponding concatenation layer reads the convolution result from the ring buffer.

Another possible embodiment of the application discloses a non-transitory computer readable storage medium which stores a plurality of instructions. When the plurality of instructions stored in the non-transitory computer readable storage medium are executed by a computer, the computer performs the above compilation method according to one embodiment of the application.

One embodiment of the application discloses an innovative neural network graph transformation for fusion and tiling in pipeline manner. In one embodiment of the application, partial output data are cached in ring buffer to reduce memory footprint when the target hardware platform (for example but not limited by, DLA) performs the set of instructions (i.e. the intermediate representation) compiled from the multi-pass compiler.

In one embodiment of the application, SW tiles are scheduled to reduce response time (the response time indicating time needed for generating the first partial output data).

In one embodiment of the application, pipelined independent compute units can run once receiving partial data which is needed without waiting all data. Thus, the total computation time is reduced and throughput is enhanced.

Many specific details are described in the present disclosure. However, these specific details should not be interpreted as restrictions of the scope of protection of the claims; rather, they should be regarded as descriptions of the features of specific implementations. In the disclosure, a sub-combination of some features described in the context of a single embodiment can be implemented in one single embodiment. Conversely, various features described in the context of one single embodiment can be implemented in one or a suitable sub-combination of several embodiments. Initially, the descriptions may suggest that some features would function only when they are included in some combinations, and such combinations may even be specified. However, under some circumstances, one or some features can be deleted from the said combinations, which are related to one specific sub-combination or variations thereof. Similarly, although the operations of the method are illustrated in a specific order, it does not mean that these operations must be executed according to the illustrated order or that all illustrated operations must be executed in order to achieve desired results.

While the invention has been described by way of example and in terms of the preferred embodiment(s), it is to be understood that the invention is not limited thereto. Based on the technical features embodiments of the present disclosure, a person ordinarily skilled in the art will be able to make various modifications and similar arrangements and procedures without breaching the spirit and scope of protection of the invention. Therefore, the scope of protection of the present disclosure should be accorded with what is defined in the appended claims.

What is claimed is:

1. A compilation method, comprising:
obtaining data representing a first graph characterizing the operations of a first neural network;
processing the data representing the first graph to transform the first graph into a second graph;
generating a set of instructions for characterizing the second graph; and
providing the set of instructions to one or more hardware platforms,
wherein the second graph includes a first partial transformed graph and a second partial transformed graph,
the first partial transformed graph includes a plurality of convolution layers serially connected to generate a first partial output data based on a first part of an input data,
the second partial transformed graph includes a plurality of convolution layers and a plurality of concatenation layers, the concatenation layer of the second partial transformed graph receiving convolution results from a corresponding convolution layer of the first partial transformed graph and a previous corresponding convolution layer of the second partial transformed graph for generating a concatenation result to a next corresponding convolution layer of the second partial transformed graph or as a second partial output data, the convolution layer of the second partial transformed graph receiving a second part of the input data or a concatenation result from a previous corresponding concatenation layer of the second partial transformed graph for generating a convolution result to a next corresponding concatenation layer of the second partial transformed graph.

2. The compilation method according to claim 1, the second graph further includes a third partial transformed graph, wherein
the third partial transformed graph includes a plurality of convolution layers and a plurality of concatenation layers, the concatenation layer of the third partial transformed graph receiving a convolution result from a corresponding convolution layer of the third partial transformed graph and a concatenation result from a corresponding concatenation layer of the second partial transformed graph for generating a concatenation result to a next corresponding convolution layer of the third partial transformed graph, the convolution layer of the third partial transformed graph receiving a third part of the input data or a concatenation result from a previous corresponding concatenation layer of the third partial transformed graph for generating a third partial output data or a convolution result to a next corresponding concatenation layer of the third partial transformed graph.

3. The compilation method according to claim 1, wherein the compilation method further includes determining the concatenation result is stored in a ring buffer for the next corresponding convolution layer to read, and the convolution result is stored in the ring buffer for the next corresponding concatenation layer to read.

4. The compilation method according to claim 1, the compilation method further includes allocating memory size for the concatenation result and the convolution result.

5. The compilation method according to claim 2, wherein
the first graph comprises a plurality of convolution layers serially connected;
the step of processing the data representing the first graph to transform the first graph into the second graph includes:
determining the number N of tiles of the input data;
dividing each convolution layer in the first graph into M convolution layers, wherein M is smaller than N or equal to N, wherein the different convolution layers divided from one convolution layer in the first graph are in different partial transformed graphs, respectively, and the first convolution layer in the first graph is divided into N convolutions layers.

6. The compilation method according to claim 5, the step of processing the data representing the first graph to transform the first graph into a second graph further includes:
determining execution order of the plurality of convolution layers of the first partial transformed graph, the plurality of convolution layers of the second partial transformed graph, the plurality of concatenation layers of the second partial transformed graph, the plurality of convolution layers of the third partial transformed graph and the plurality of concatenation layers of the third partial transformed graph, and
generating the second graph based on the execution order.

7. The compilation method according to claim 2, wherein
the first partial transformed graph includes a first convolution layer, a second convolution layer and a third convolution layer,
the first convolution layer receives the first part of the input data and performs convolution operations on the first part of the input data to generate a first convolution result to the second convolution layer,
the second convolution layer receives the first convolution result from the first convolution layer and performs convolution operations on the first convolution result to generate a second convolution result to the third convolution layer, and
the third convolution layer receives the second convolution result from the second convolution layer and performs convolution operations on the second convolution result to generate a third convolution result as the first partial output data.

8. The compilation method according to claim 7, wherein
the second partial transformed graph includes a fourth convolution layer, a fifth convolution layer, a sixth convolution layer, a first concatenation layer, a second concatenation layer, and a third concatenation layer,
the fourth convolution layer receives the second part of input data and performs convolution operations on the second part of input data to generate a fourth convolution result to the first concatenation layer,
the first concatenation layer performs concatenation operations on the first convolution result from the first convolution layer and the fourth convolution result from the fourth convolution layer to generate a first concatenation result to the fifth convolution layer,
the fifth convolution layer receives the first concatenation result and performs convolution operations on the first concatenation result to generate a fifth convolution result to the second concatenation layer,
the second concatenation layer performs concatenation operations on the second convolution result from the second convolution layer and the fifth convolution result from the fifth convolution layer to generate a second concatenation result to the sixth convolution layer,
the sixth convolution layer receives the second concatenation result and performs convolution operations on the second concatenation result to generate a sixth convolution result to the third concatenation layer, and
the third concatenation layer performs concatenation operations on the third convolution result from the third convolution layer and the sixth convolution result from the sixth convolution layer to generate a third concatenation result as the second partial output data.

9. The compilation method according to claim 8, wherein
the third partial transformed graph includes a seventh convolution layer, an eighth convolution layer, a ninth convolution layer, a fourth concatenation layer, a fifth concatenation layer and a sixth concatenation layers,
the seventh convolution layer receives the third part of the input data and performs convolution operations on the third part of input data to generate a seventh convolution result to the fourth concatenation layer,
the fourth concatenation layer performs concatenation operations on the seventh convolution result from the seventh convolution layer and the first concatenation result from the first concatenation layer to generate a fourth concatenation result to the eighth convolution layer,
the eighth convolution layer receives the fourth concatenation result and performs convolution operations on the fourth concatenation result to generate an eighth convolution result to the fifth concatenation layer,
the fifth concatenation layer performs concatenation operations on the eighth convolution result from the eighth convolution layer and the second concatenation result from the second concatenation layer to generate a fifth concatenation result to the ninth convolution layer,
the ninth convolution layer receives the fifth concatenation result and performs convolution operations on the fifth concatenation result to generate a ninth convolution result, and
the sixth concatenation layer performs concatenation operations on the ninth convolution result from the ninth convolution layer to generate a sixth concatenation result as the third partial output data.

10. A data processing method, comprising:
receiving a set of instructions for characterizing a graph;
obtaining input data; and
performing the set of instructions on the input data for generating output data;
wherein the graph includes a first partial transformed graph and a second partial transformed graph,
the first partial transformed graph includes a plurality of convolution layers serially connected to generate a first partial output based on a first part of an input data,
the second partial transformed graph includes a plurality of convolution layers and a plurality of concatenation layers, the concatenation layer of the second partial transformed graph receiving convolution results from a corresponding convolution layer of the first partial transformed graph and a previous corresponding convolution layer of the second partial transformed graph for generating a concatenation result to a next corresponding convolution layer of the second partial transformed graph or as a second partial output, the convolution layer of the second partial transformed graph receiving a second part of the input data or a concatenation result from a previous corresponding concatenation layer of the second partial transformed graph for generating a convolution result to a next corresponding concatenation layer of the second partial transformed graph.

11. The data processing method according to claim 10,
wherein the second graph further includes a third partial transformed graph,
wherein the third partial transformed graph includes a plurality of convolution layers and a plurality of concatenation layers, the concatenation layer of the third partial transformed graph receiving a convolution result from a corresponding convolution layer of the third partial transformed graph and a concatenation result from a corresponding concatenation layer of the second partial transformed graph for generating a concatenation result to a next corresponding convolution layer of the third partial transformed graph, the convolution layer of the third partial transformed graph receiving a third part of the input data or a concatenation result from a previous corresponding concatenation layer of the third partial transformed graph for generating a third partial output or a convolution result to a next corresponding concatenation layer of the third partial transformed graph.

12. The data processing method according to claim 10, further comprising: outputting the first partial output to a next computing unit before the second partial output is generated.

13. The data processing method according to claim 10, wherein the concatenation result for the next corresponding convolution layer is stored in a ring buffer, and the next corresponding convolution layer reads the concatenation result from the ring buffer, the convolution result for the next corresponding concatenation layer is stored in the ring buffer, and the next corresponding concatenation layer reads the convolution result from the ring buffer.

14. A data processing apparatus, comprising:
a processor, and
a memory coupled to the processor,
the processor being configured for:
receiving a set of instructions for characterizing a graph;
obtaining input data; and
performing the set of instructions on the input data for generating output data;
wherein the graph includes a first partial transformed graph and a second partial transformed graph,
the first partial transformed graph includes a plurality of convolution layers serially connected to generate a first partial output based on a first part of an input data,
the second partial transformed graph includes a plurality of convolution layers and a plurality of concatenation layers, the concatenation layer of the second partial transformed graph receiving convolution results from a corresponding convolution layer of the first partial transformed graph and a previous corresponding convolution layer of the second partial transformed graph for generating a concatenation result to a next corresponding convolution layer of the second partial transformed graph or as a second partial output, the convolution layer of the second partial transformed graph receiving a second part of the input data or a concatenation result from a previous corresponding concatenation layer of the second partial transformed graph for generating a convolution result to a next corresponding concatenation layer of the second partial transformed graph;
wherein the concatenation result for the next corresponding convolution layer is stored in the memory, and the next corresponding convolution layer reads the concatenation result from the memory, the convolution result for the next corresponding concatenation layer is stored in the memory, and the next corresponding concatenation layer reads the convolution result from the memory.

15. The apparatus according to claim 14,
wherein the second graph further includes a third partial transformed graph,
wherein the third partial transformed graph includes a plurality of convolution layers and a plurality of concatenation layers, the concatenation layer of the third partial transformed graph receiving a convolution result from a corresponding convolution layer of the third partial transformed graph and a concatenation result from a corresponding concatenation layer of the second partial transformed graph for generating a concatenation result to a next corresponding convolution layer of the third partial transformed graph, the convolution layer of the third partial transformed graph receiving a third part of the input data or a concatenation result from a previous corresponding concatenation layer of the third partial transformed graph for generating a third partial output or a convolution result to a next corresponding concatenation layer of the third partial transformed graph.

16. The apparatus according to claim 14, the processor is further configured for: outputting the first partial output to a next computing unit before the second partial output is generated.
